(19) United States
(12) Patent Application Publication
(10) Pub. No.: US 2025/0314268 A1
(43) Pub. Date: Oct. 9, 2025

(54) AIR FOIL BEARING MICRO LATTICE APPARATUS AND ASSOCIATED METHODS

(71) Applicant: General Electric Company, Evendale, OH (US)

(72) Inventors: Anand M S, Bengaluru (IN); Ravindra Shankar Ganiger, Bengaluru (IN); David Raju Yamarthi, Bengaluru (IN)

(21) Appl. No.: 19/097,514

(22) Filed: Apr. 1, 2025

(30) Foreign Application Priority Data
Apr. 4, 2024 (IN) 202411027931

(51) Int. Cl. F16C 17/04

(52) U.S. Cl. CPC F16C 17/042; F16C 2202/00; F16C 2223/30

(57) ABSTRACT

Systems, apparatus, articles of manufacture, and methods are disclosed that include an air foil bearing, the air foil bearing comprising: a thrust disc coupled to a rotor shaft, the thrust disc and rotor shaft to rotate; a thrust pad aligned with a first side of the thrust disc, the thrust pad to engage with the thrust disc as the thrust disc rotates; and a micro lattice structure between the thrust disc and the thrust pad, the micro lattice structure to mitigate the thrust pad engaging with the thrust disc.

### RELATED APPLICATION

This patent claims the benefit of Indian Provisional Patent Application No. 20/241,1027931, which was filed on Apr. 4, 2024. Indian Provisional Patent Application No. 20/241,1027931 is hereby incorporated herein by reference in its entirety. Priority to Indian Provisional Patent Application No. 20/241,1027931 is hereby claimed.

### FIELD OF THE DISCLOSURE

This disclosure relates generally to aerophilic materials and micro lattices and, more particularly, to aerophilic materials and micro lattice structured surfaces for air foil bearings.

### BACKGROUND

An air foil bearing, also known as an aerodynamic foil bearing, is a fluid film bearing operating on lubrication using a thin film of air to support a rotating shaft. Air foil bearings are designed to operate in high-speed and high-temperature environments, making air foil bearings suitable for use in turbomachinery, such as gas turbines. In recent years, there has been a trend away from oil-based lubricants to accommodate reduced maintenance requirements and maintaining pressure at higher loads for radial type bearings or thrust imbalances for axial type bearings.

Air foil bearings may be radial type or axial type bearings. Radial type bearings support a rotating shaft radially, meaning that the bearing provides support perpendicular to the axis of rotation. Radial type air foil bearings withstand radial loads, which are forces that act perpendicular to the rotating shaft's axis. Axial type bearings support the rotating shaft axially, meaning the axial type bearing supports the rotating shaft parallel to the axis of rotation. Axial type bearings withstand axial loads, which are forces that act parallel to the rotating shaft's axis.

### BRIEF DESCRIPTION OF THE DRAWINGS

FIG. 1A is a diagram of a prior radial air foil bearing.

FIG. 1B is a magnified view of the prior radial air foil bearing of FIG. 1A.

FIG. 2 is a diagram of an axial air foil bearing with an aerophilic coating on a first and second thrust pad.

FIG. 3 is a diagram of an axial air foil bearing with an aerophilic coating on a thrust disc.

FIG. 4A is a diagram of an air foil bearing with a micro lattice structure in a decompressed state.

FIG. 4B is a diagram of the air foil bearing of FIG. 4A in a compressed state.

FIG. 5A is a diagram of a first radial air foil bearing with micro lattice structure.

FIG. 5B is a magnified view of the first radial air foil bearing of FIG. 5A.

FIG. 6A is a diagram of a second radial air foil bearing with a micro lattice structure coating.

FIG. 6B is a magnified view of the second radial air foil bearing of FIG. 6A.

FIG. 6C is a magnified view of the second radial air foil bearing of FIG. 6A with a perforated plate embedded with aerophilic material.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

An air foil bearing is included within a housing having holes. When a rotating shaft, also referred to as the rotor shaft, rotates, air is pulled into the bearing housing through the holes. The air drawn into the bearing forms a thin film of pressurized air between bump foils of the bearing and the rotor shaft. The pressurized air acts as a lubricant, reducing friction and allowing the shaft to rotate.

Despite the presence of the pressurized air, thrust discs within the air foil bearing may come into contact with thrust pads during operation. Thrust discs are components that transmit axial forces along the shaft, while thrust pads are stationary components that support the axial forces. There is a predetermined distance between the thrust disc and thrust pads known as a clearance. If the clearance between the thrust disc and thrust pads reduces due to movement of the thrust disc during rotation of the rotor shaft, the thrust disc and thrust pads may come into contact, leading to friction and wear on the components. This process in known as the thrust disc “engaging” the thrust pad. The thrust disc engages the thrust pad by narrowing the predetermined distance between the thrust disc and the thrust pad or by moving toward the thrust pad.

In examples disclosed herein, micro lattice structures are used to facilitate controlling the clearance between a thrust disc and thrust pads. A micro lattice structure is a type of material characterized by low density and a high strength-to weight ratio. A micro lattice structure is composed of interconnected struts or beams arranged in a lattice pattern to create a three-dimensional mesh. Micro lattice structures are porous, with the majority of the structure volume including air or another gas. In examples disclosed herein, supercritical carbon dioxide (SCO2), helium, nitrogen, hydrogen, or other gases may constitute the gas used in the micro lattice structure. The micro lattice structures used herein may include graphite, graphene, nickel, titanium, aluminum, steel, or a composite metal foam material. Micro lattice structures are commonly electro-deposited, cold sprayed, or three-dimensionally-printed onto a surface, but may be manufactured in other methods.

As an alternate to micro lattice structures, growing or bonding aerophilic material on the regions indicated is a suitable alternate. The aerophilic material, coatings, or micro lattice structures form meshes with highly compressible structures that retain air in micro-cavities. Examples of aerophilic materials include, but are not limited to, titanium, carbon reinforced polymers, aluminum alloys, composite materials, and/or ceramic matrix composites. Upon increase in pressure above a predetermined threshold, an aerophilic material, a coating, or a micro lattice structure compresses and releases the air or gas entrapped within the mesh. The compression and release of the entrapped air or gas is often referred to as capillary action. The air or gas increases the air stiffness in the surrounding environment to facilitate balancing of the thrust disc and reducing the likelihood of contact between the thrust disc and thrust pads for an axial foil bearing, or hydrodynamically assist a radial air foil bearing. The aerophilic material, also referred to as an aerophilic material coating, conforms to a surface to which the aerophilic material coating is applied. In doing so, the aerophilic material coating entraps air (or another fluid) that can be released through capillary action during compression of the aerophilic material coating.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, a micro lattice structure is used in the examples. As an alternate, an aerophilic material coating with micro pores may be applied to perform the same function by entrapping air to be released in a compressed state.

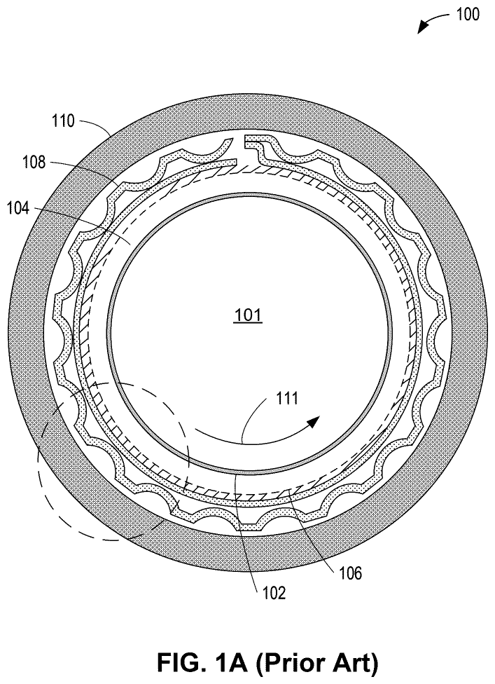

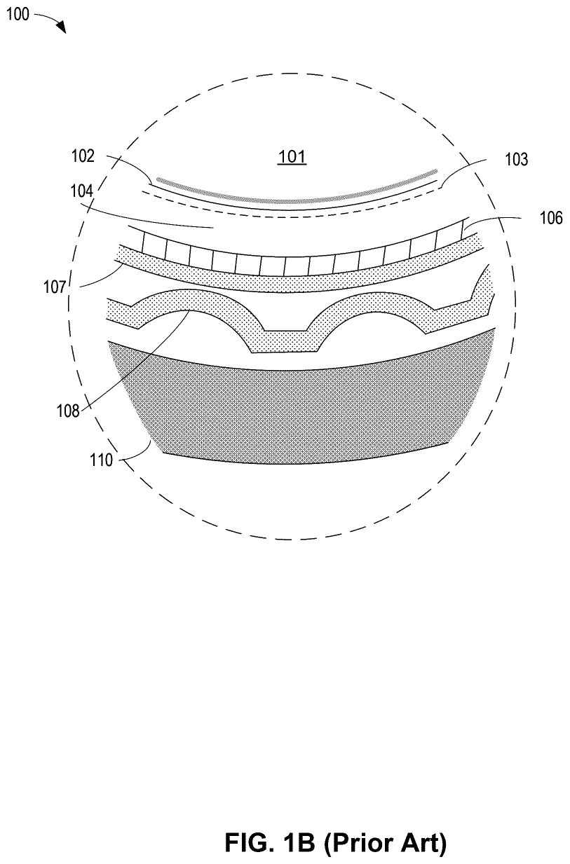

FIG. 1A is a diagram of an example prior radial air foil bearing 100 in which an example wear resistant layer operates to mitigate contact between radial surfaces. The example prior radial air foil bearing 100 of FIG. 1A includes a rotor shaft 101, a coating 102, a fluid 104, an Aluminum-Copper (Al-Cu) layer 106, an elastic foundation 108 (also referred to as a bump foil), and a housing 110.

In assembly, the rotor shaft 101 of FIG. 1A is coupled to the coating 102, with the coating 102 being radially outward from the rotor shaft 101. In the example of FIG. 1A, the coating 102 is a PS304 coating. In other examples, the coating 102 may be any high-temperature coating. The fluid 104 surrounds (further outwardly) the coating 102. The fluid 104 is outwardly coupled to the Al-Cu layer 106. The Al-Cu layer 106 is outwardly coupled to the elastic foundation 108, which is surrounded by the housing 110.

In operation, the rotor shaft 101 of FIG. 1A acts to rotate counterclockwise in the direction of rotation 111. The fluid 104 (typically air) flows over the curved surface of the rotor shaft 101, coated in the coating 102. The fluid 104 accelerates due to flowing over the curved shape which reduces fluid pressure while the centrifugal force generated by the rotation causes the fluid 104 to move outward. The combination of the pressure drop and outward movement of the fluid 104 creates a net flow of the fluid 104 in the radial direction.

FIG. 1B is a magnified view of the example prior radial air foil bearing 100 in which wear resistant coatings operate to mitigate contact between radial surfaces. The example prior radial air foil bearing 100 of FIG. 1B includes the rotor shaft 101, the coating 102, a Molybdenum Disulfide (MoS2) overlay 103, the fluid 104, the Al-Cu layer 106, a top foil 107, the bump foil 108, and the housing 110.

In assembly, the rotor shaft 101 of FIG. 1B is coupled to the coating 102, with the coating 102 being radially outward from the rotor shaft 101. The MoS2 layer is overlaid (further outwardly) onto the coating 102. The fluid 104 surrounds (further outwardly) the MoS2 overlay 103. The fluid 104 is outwardly coupled to the Al-Cu layer 106. The top foil 107 surrounds the Al-Cu layer 106. The top foil 107 is outwardly coupled to the elastic foundation 108, which is surrounded by the housing 110.

In operation, the MoS2 overlay 103 and the Al-Cu layer 106 of FIG. 1B act to provide a wear resistant layer. As the rotor shaft 101 rotates, heat is generated and causes the shaft to expand in a radial direction. The expansion of the rotor shaft 101 causes the rotor shaft 101 to engage with the top foil 107. The wear resistant layers of the MoS2 overlay 103 and the Al-Cu layer 106 protect the surfaces of the rotor shaft 101 and the top foil 107 from damage resultant from friction, abrasion, and/or erosion during operation. The MoS2 overlay and Al-Cu layer absorb the wear to make the components more durable than if there were no wear resistant layers.

There are disadvantages associated with wear resistance coatings. These disadvantages include uneven wear on the coating due to uneven loading leading to an inconsistent clearance, the wear resistant layer degrading over time, and the thermal conductivity of the material limiting the types of materials that can be used in the environment of a gas turbine engine.

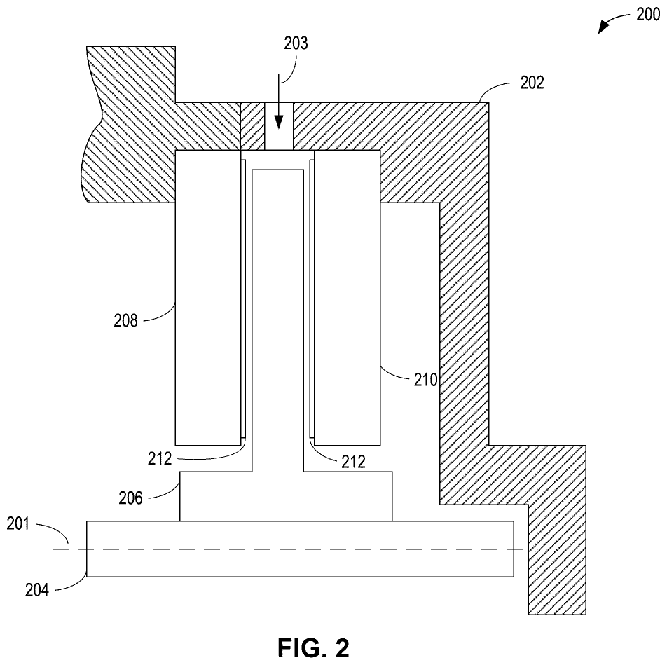

FIG. 2 is a diagram of an example axial air foil bearing 200 in which an example micro lattice structure operates to balance a thrust disc between a first thrust pad and a second thrust pad. The axial air foil bearing 200 of FIG. 2 includes a housing 202, airflow 203, a rotor shaft 204, a thrust disc 206, a first thrust pad 208, a second thrust pad 210, and a micro lattice structure 212. The micro lattice structure 212 may be an aerophilic material coating or may be formed of graphite, graphene, nickel, titanium, aluminum, steel, or composite metal foams.

In assembly, the rotor shaft 204 of FIG. 2 is coupled to a motor (not shown) and is encased within the housing 202. The thrust disc 206 is coupled to the rotor shaft 204 in between the first thrust pad 208 and the second thrust pad 210. The first thrust pad 208 and the second thrust pad 210 are held in place by the housing 202 circumferentially around the rotor shaft 204. A micro lattice structure 212 is coupled to an internal surface (the surface facing the thrust disc 206) on the first thrust pad 208 and the second thrust pad 210. The first thrust pad 208 is aligned with a first side of the thrust disc 206, which is opposite of the second side of the thrust disc 206 (and also aligned with the second thrust pad 210).

In operation, the rotor shaft 204 of FIG. 2 acts to rotate, pulling airflow 203 into the housing 202. The thrust disc 206 is attached to the rotor shaft 204 and rotates circumferentially around the rotor shaft 204 in between the first thrust pad 208 and the second thrust pad 210. In order to prevent movement in a direction parallel to a centerline axis 201 of the rotor shaft 204 causing contact, friction, and subsequent wear between the thrust disc 206 and the first thrust pad 208 or the second thrust pad 210, the micro lattice structure 212 retains a fluid. As the rotor shaft 204 and correspondingly the thrust disc 206 rotate, the micro lattice structure 212 compresses and releases fluid if the thrust disc 206 becomes off-balance and nears the first thrust pad 208 or the second thrust pad 210. As the thrust disc 206 rebalances, the micro lattice structure 212 decompresses to entrap fluid within the micro lattice structure 212. The process repeats if the thrust disc 206 becomes off balance, effectively creating a fluid bearing.

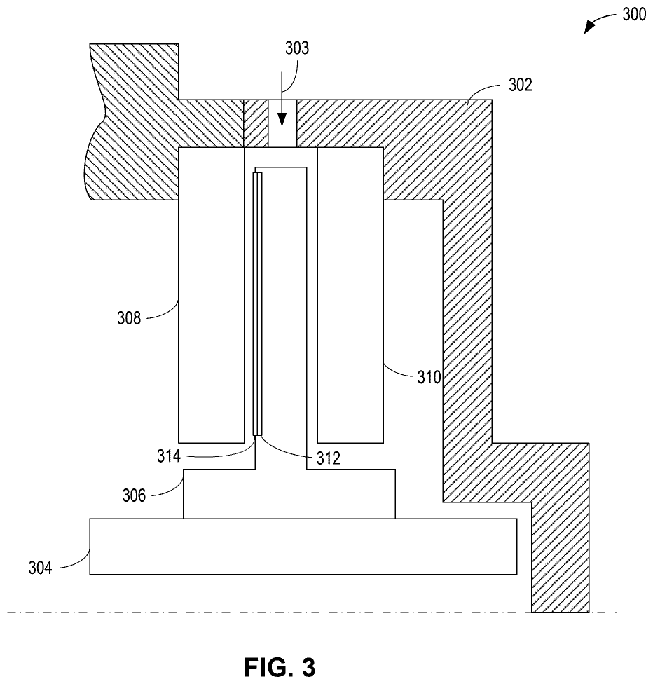

FIG. 3 is a diagram of a second example axial foil bearing 300 in which an example micro lattice structure operates to balance a thrust disc between a first thrust pad and a second thrust pad. The second example axial foil bearing 300 of FIG. 3 includes a housing 302, airflow 303, a rotor shaft 304, a thrust disc 306, a first thrust pad 308, a second thrust pad 310, metal inserts 312, and a micro lattice structure 314. The micro lattice structure 314 may be an aerophilic material coating or may be formed of graphite, graphene, nickel, titanium, aluminum, steel, or composite metal foams.

In assembly, the rotor shaft 304 of FIG. 3 is coupled to a motor (not shown) and is encased within the housing 302. The thrust disc 306 is coupled to the rotor shaft 304 in between the first thrust pad 308 and the second thrust pad 310. The first thrust pad 308 and the second thrust pad 310 are held in place by the housing 302 circumferentially around the rotor shaft 304. Metal inserts 312 are coupled to the thrust disc 306 on at least one side of the thrust disc 306 to retain a micro lattice structure 314.

In operation, the rotor shaft 304 of FIG. 3 acts to rotate, pulling airflow 303 into the housing 302. The thrust disc 306 is attached to the rotor shaft 304 and rotates circumferentially around the rotor shaft 304 in between the first thrust pad 308 and the second thrust pad 310. In order to prevent contact, friction, and subsequent wear between the thrust disc 306 and the first thrust pad 308 or the second thrust pad 310, the micro lattice structure 314 retains a fluid. As the rotor shaft 304 and correspondingly the thrust disc 306 rotate, the micro lattice structure 314 compresses and releases air if the thrust disc 306 becomes off-balance and nears the first thrust pad 308 or the second thrust pad 310. As the thrust disc 306 rebalances, the micro lattice structure decompresses to entrap fluid within the micro lattice structure 314. The process repeats if the thrust disc 306 becomes off balance, effectively creating a fluid bearing.

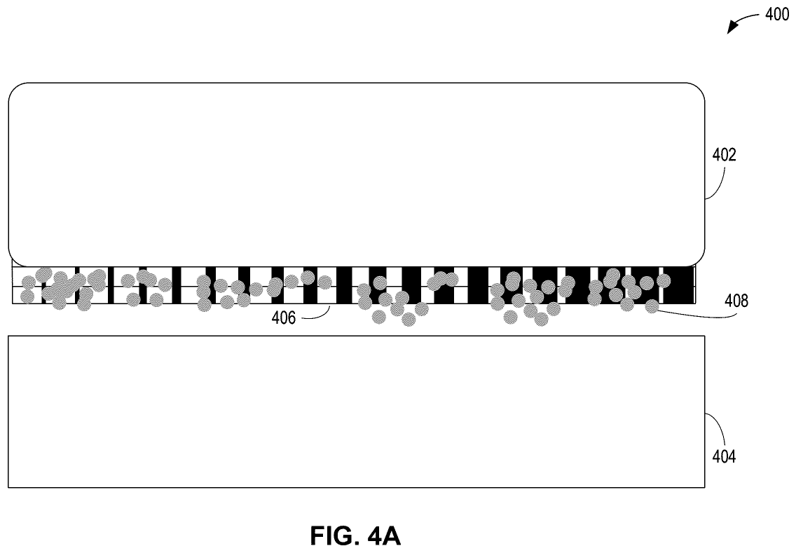

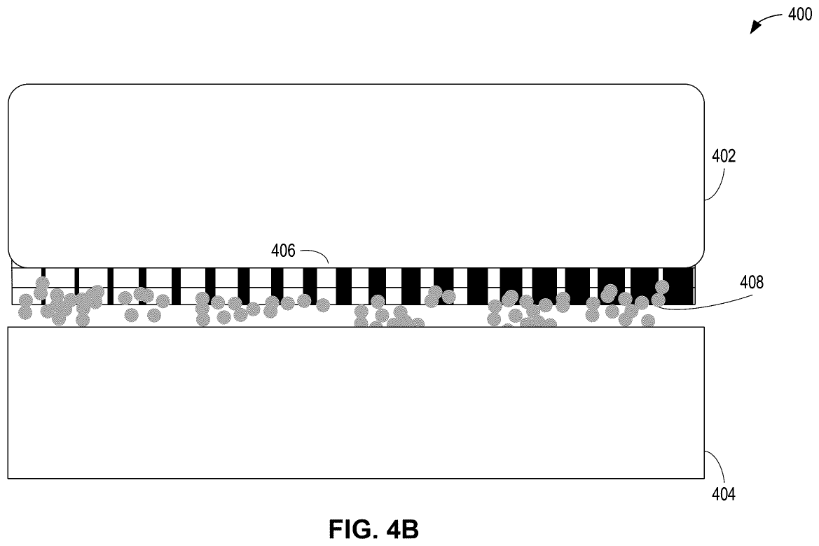

FIG. 4A is a diagram of an example thrust disc and thrust pad combination 400 in which an example micro lattice structure is decompressed and operates to retain a fluid. The thrust disc and thrust pad combination 400 of FIG. 4 includes a thrust pad 402, a thrust disc 404, a micro lattice structure 406, and a fluid 408.

In assembly of the example thrust disc and thrust pad combination 400 of FIG. 4A, the thrust pad 402 is offset from the thrust disc 404 by a distance. The micro lattice structure 406 is coupled to a surface of the thrust pad 402 facing the thrust disc 404. The micro lattice structure 406 retains the fluid 408. In other examples, the micro lattice structure 406 may be coupled to a surface of the thrust disc 404 facing the thrust pad 402.

In operation, the micro lattice structure 406 of FIG. 4A acts to retain the fluid 408 in a decompressed state where the distance between the thrust pad 402 and the thrust disc 404 remains constant.

FIG. 4B is a diagram of the example thrust disc and thrust pad combination 400 in which an example micro lattice structure is compressed, and the fluid operates to balance the thrust disc. The example thrust disc and thrust pad combination 400 of FIG. 4B includes the thrust pad 402, the thrust disc 404, the micro lattice structure 406, and the fluid 408. Examples of the fluid 408 include aerophilic coatings, air, or gases such as supercritical carbon dioxide, hydrogen, helium, nitrogen, etc. Example micro lattice structures 406 can include graphite, graphene, nickel, titanium, aluminum, steel, composite metal foams, or a mixture thereof. The micro lattice structure 406 can be electro-deposited, cold sprayed, or three-dimensionally printed in a desired location.

In assembly of the example thrust disc and thrust pad combination 400 of FIG. 4B, the thrust pad 402 is offset from the thrust disc 404 by a distance. The micro lattice structure 406 is coupled to a surface of the thrust pad 402 facing the thrust disc 404. The micro lattice structure 406 is compressed so that the fluid 408 is freely flowing between the thrust pad 402 and the thrust disc 404. In other examples, the micro lattice structure 406 may be coupled to a surface of the thrust disc 404 facing the thrust pad 402.

In operation, the micro lattice structure 406 of FIG. 4B is compressed, allowing the fluid 408 to release from the micro lattice structure 406 through capillary action. The release of the fluid 408 from the micro lattice structure form an air bearing by increasing the hydrodynamic pressure in between the thrust disc a 404 and the thrust pad 402. The distance between the thrust pad 402 and the thrust disc 404 is smaller in FIG. 4B than in FIG. 4A, showing the compression of the micro lattice structure 406. As a result of the compression, the micro lattice structure 406 undergoes the capillary action described above to release the fluid 408 (e.g., air) into the gap between the thrust pad 402 and the thrust disc 404. The release of the fluid 408 into the gap has an effect of increasing the air stiffness in the gap, which results in rebalancing of the thrust disc 404. FIG. 4B. and the compressed state of the micro lattice structure 406 is contrasted with the decompressed state of the micro lattice structure 406 in FIG. 4A.

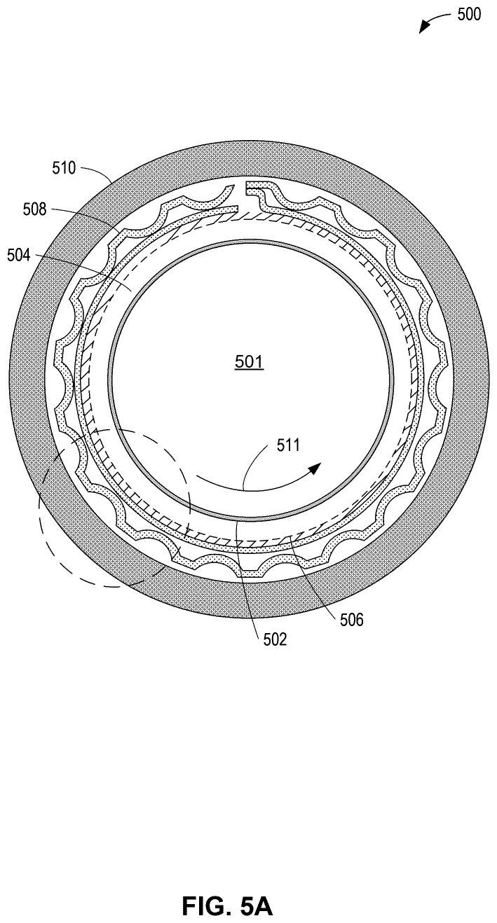

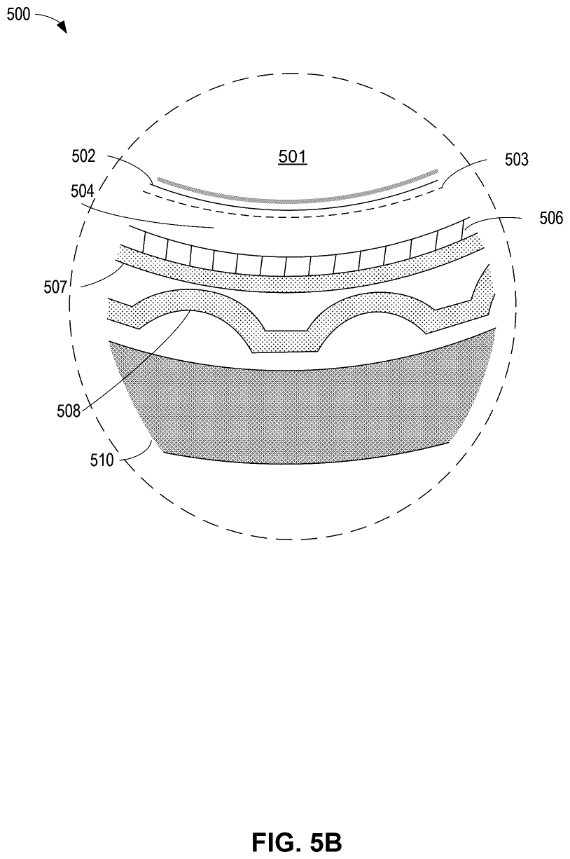

FIG. 5A is a diagram of an example radial air foil bearing 500 in which an example micro lattice structure operates to mitigate contact between radial surfaces. The example radial air foil bearing 500 of FIG. 5A includes a rotor shaft 501, a coating 502, a fluid 504, a first micro lattice structure 506, an elastic foundation 508 (also referred to as a bump foil), and a housing 510.

In assembly, the rotor shaft 501 of FIG. 5A is coupled to the coating 502, with the coating 502 being radially outward from the rotor shaft 501. In the example of FIG. 5A, the coating 502 is a PS304 coating. In other examples, the coating 502 may be any high-temperature coating. The fluid 504 surrounds (further outwardly) the coating 502. The fluid 504 is outwardly coupled to the first micro lattice structure 506. The first micro lattice structure 506 is outwardly coupled to the elastic foundation 508, which is surrounded by the housing 510.

In operation, the rotor shaft 501 of FIG. 5A acts to rotate counterclockwise in the direction of rotation 511. The fluid 504 (typically air) flows over the curved surface of the rotor shaft 501, coated in the coating 502. The fluid 504 accelerates due to flowing over the curved shape which reduces fluid pressure while the centrifugal force generated by the rotation causes the fluid 504 to move outward. The combination of the pressure drop and outward movement of the fluid 504 creates a net flow of the fluid 504 in the radial direction.

FIG. 5B is a magnified view of an example radial air foil bearing 500 in which an example micro lattice structure operates to mitigate contact between radial surfaces. The example radial air foil bearing 500 of FIG. 5B includes the rotor shaft 501, the coating 502, a second micro lattice structure 503, the fluid 504, the first micro lattice structure 506, a top foil 507, the bump foil 508, and the housing 510.

In assembly, the rotor shaft 501 of FIG. 5B is coupled to the coating 502, with the coating 502 being radially outward from the rotor shaft 501. The second micro lattice structure 503 is overlaid (further outwardly) onto the coating 502. The fluid 504 surrounds (further outwardly) the second micro lattice structure 503. The fluid 504 is outwardly coupled to the first micro lattice structure 506. The top foil 507 surrounds the first micro lattice structure 506. The top foil 507 is outwardly coupled to the elastic foundation 508, which is surrounded by the housing 510.

In operation, the second micro lattice structure 503 and the first micro lattice structure 506 of FIG. 5B act to mitigate the rotor shaft 501 engaging with the top foil 507. As the rotor shaft 501 rotates, heat is generated and causes the shaft to expand in a radial direction. The expansion of the rotor shaft 501 causes the rotor shaft 501 to engage with the top foil 507. To mitigate the rotor shaft 501 engaging with the top foil 507, the first micro lattice structure 506 and/or the second micro lattice structure 503 uses capillary action to increase the fluid pressure in the fluid 504. The increase in fluid pressure increases the air or fluid stiffness, effectively rebalancing the radial air foil bearing 500.

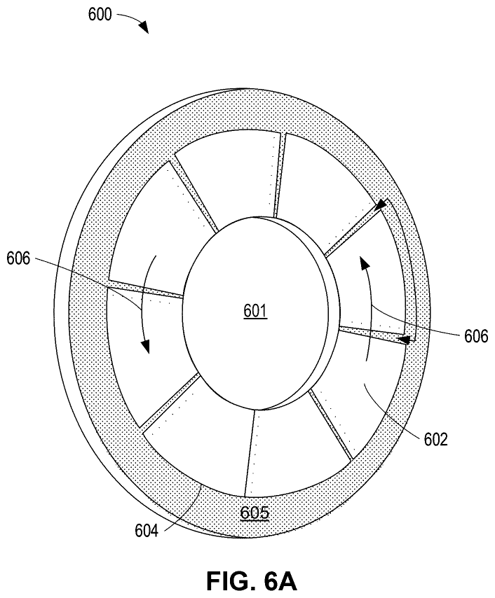

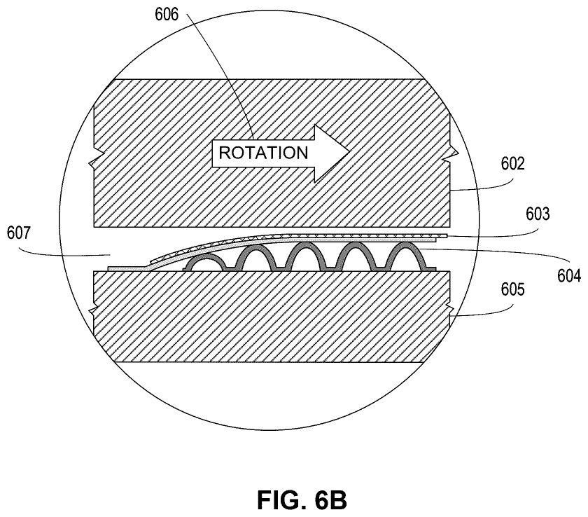

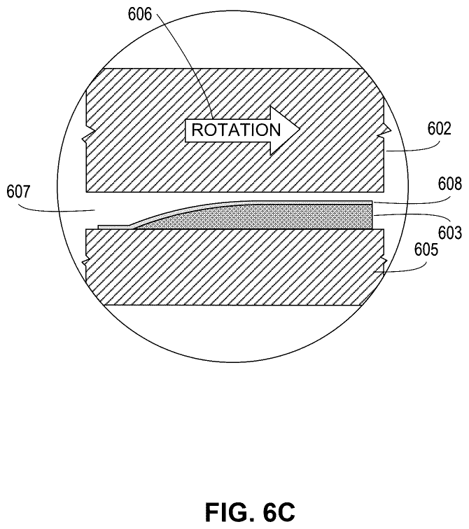

FIG. 6A is a diagram of a second example radial air foil bearing 600 in which an example radial air foil bearing operates to incorporate a micro lattice structure. The second example radial air foil bearing 600 of FIG. 6A includes a rotor shaft 601, a top foil 602, a bump foil 604, and a housing 605.

In assembly, the rotor shaft 601 is coupled to the top foil 602 so that the top foil 602 has sections surrounding the rotor shaft 601. Radially outward of the top foil 602 is the bump foil 604. The housing 605 is surrounds and is coupled to the bump foil 604.

In operation, the rotor shaft 601 of FIG. 6A rotates in the direction of rotation 606. The top foil 602 rotates with the rotor shaft 601 as the top foil 602 is coupled to the rotor shaft 601. The bump foil 604 and housing 605 are stationary with respect to the rotor shaft 601 and top foil 602 rotating.

FIG. 6B is a magnified view of the second example radial air foil bearing 600 in which an example micro lattice structure operates to retain a fluid. The second example radial air foil bearing 600 of FIG. 6B includes the top foil 602, a micro lattice structure 603, a bump foil 604, a housing 605, and air 607.

In assembly, the housing 605 is coupled to the bump foil 604, which extends radially inward from the housing 605. A micro lattice structure is coupled to the bump foil 604, resting on top of the bump foil 604 in a radially inward direction. Radially inward of the micro lattice structure is the top foil 602.

In operation, the micro lattice structure 603 of FIG. 6B acts to mitigate engaging of the top foil 602 with the bump foil 604. As the top foil 602 rotates in the direction of rotation 606, the top foil 602 expands and/or moves in a radial direction. The expansion and/or movement radially compresses the micro lattice structure 603 as the top foil 602 engages the bump foil 604. The compression of the micro lattice structure 603 causes capillary action, where the fluid entrapped by the micro lattice structure 603 is released through the compression, resulting in an increase in the pressure of the air 607. The increase in air pressure rebalances the radial air foil bearing 600.

FIG. 6C is a magnified view of a second example radial air foil bearing 600 in which an example perforated plate operates to retain and release aerophilic material. The second example radial air foil bearing 600 of

FIG. 6C includes the top foil 602, a micro lattice structure 603, a housing 605, air 607, and a perforated plate 608.

In assembly, the housing 605 of FIG. 6C is coupled to the micro lattice structure 603 in a radially inward direction. A perforated plate 608 rests on the micro lattice structure 603 in a radially inward direction. The top foil 602 is disposed at a distance radially inward from the perforated plate 608.

In operation, the perforated plate 608 of FIG. 6C acts to mitigate engaging of the top foil 602 with the bump foil 604. As the top foil 602 rotates in the direction of rotation 606, the top foil 602 expands and/or moves in a radial direction. The expansion and/or movement radially compresses the perforated plate 608 as the top foil 602 engages the bump foil 604. The compression of the perforated plate 608 causes capillary action, where the aerophilic material entrapped by the perforated plate 608 is released through the perforations, resulting in an increase in the pressure of the air 607. The increase in air pressure rebalances the radial air foil bearing 600.

From the foregoing, it will be appreciated that example systems, apparatus, articles of manufacture, and methods have been disclosed that mitigate the engagement of a thrust disc with a thrust pad. Disclosed systems, apparatus, articles of manufacture, and methods improve air foils by using micro lattice structures or aerophilic materials to reduce wear and contact between thrust discs and thrust pads. Disclosed systems, apparatus, articles of manufacture, and methods are accordingly directed to one or more improvement(s) in the operation of a machine such as a computer or other electronic and/or mechanical device.

Further aspects of the present disclosure are provided by the subject matter of the following clauses:

An example axial air foil bearing comprising a thrust disc coupled to a rotor shaft, the thrust disc and rotor shaft to rotate, a thrust pad aligned with a first side of the thrust disc, the thrust pad to engage with the thrust disc as the thrust disc rotates, and a micro lattice structure between the thrust disc and the thrust pad, the micro lattice structure to mitigate the thrust pad engaging with the thrust disc.

The example axial air foil bearing of any preceding clause, wherein the micro lattice structure is coupled to the thrust disc.

The example axial air foil bearing of any preceding clause, wherein the micro lattice structure is coupled to the thrust pad.

The example axial air foil bearing of any preceding clause, wherein the thrust pad is a first thrust pad, and further including a second thrust pad, the second thrust pad aligned with a second side of the thrust disc, the first side of the thrust disc opposite the second side of the thrust disc.

The example axial air foil bearing of any preceding clause, wherein the micro lattice structure is a first micro lattice structure, and further including a second micro lattice structure, the second micro lattice structure between the second thrust pad and the second side of the thrust disc.

The example axial air foil bearing of any preceding clause, wherein the micro lattice structure entraps fluid within the micro lattice structure.

The example axial air foil bearing of any preceding clause, wherein the fluid is at least one of air, supercritical carbon dioxide, hydrogen, helium, and nitrogen.

The example axial air foil bearing of any preceding clause, wherein the micro lattice structure comprises at least one of graphite, graphene, nickel, titanium, aluminum, steel, and a composite metal foam.

The example axial air foil bearing of any preceding clause, wherein the micro lattice structure is at least one of electro-deposited, cold sprayed, or three-dimensionally-printed.

The example axial air foil bearing of any preceding clause, further including a perforated plate, the perforated plate to retain a fluid.

An example air foil bearing assembly including a rotor shaft to rotate within a housing, a thrust disc fixed to the rotor shaft, a first thrust pad fixed to the housing and aligned with a first side of the thrust disc, the first thrust pad to engage with the thrust disc as the thrust disc rotates, a second thrust pad fixed to the housing and aligned with a second side of the thrust disc, the second thrust pad to engage with the thrust disc as the thrust disc rotates, and a micro lattice structure between the thrust disc and at least one of the first thrust pad and the second thrust pad, the micro lattice structure to mitigate movement of the thrust disc along an axis of the rotor shaft.

The example air foil bearing assembly of any preceding clause, wherein the micro lattice structure is coupled to the thrust disc.

The example air foil bearing assembly of any preceding clause, wherein the micro lattice structure is coupled to the thrust pad.

The example air foil bearing assembly of any preceding clause, wherein the micro lattice structure is a first micro lattice structure between the first side of the thrust disc and the first thrust pad, and further including a second micro lattice structure, the second micro lattice structure between the second thrust pad and the second side of the thrust disc.

The example air foil bearing assembly of any preceding clause, wherein the micro lattice structure entraps fluid within the micro lattice structure.

The example air foil bearing assembly of any preceding clause, wherein the fluid is at least one of air, supercritical carbon dioxide, hydrogen, helium, and nitrogen.

The example air foil bearing assembly of any preceding clause, wherein the micro lattice structure comprises at least one of graphite, graphene, nickel, titanium, aluminum, steel, and a composite metal foam.

The example air foil bearing assembly of any preceding clause, wherein the micro lattice structure is at least one of electro-deposited, cold sprayed, or three-dimensionally-printed.

The example air foil bearing assembly of any preceding clause, further including a perforated plate, the perforated plate to retain a fluid.

An example air foil bearing assembly comprising a rotor shaft to rotate within a housing, a thrust disc fixed to the rotor shaft, a first thrust pad fixed to the housing and aligned with a first side of the thrust disc, the first thrust pad to engage with the thrust disc as the thrust disc rotates, a second thrust pad fixed to the housing and aligned with a second side of the thrust disc, the second thrust pad to engage with the thrust disc as the thrust disc rotates, and an aerophilic material coating between at least one of (1) the thrust disc and the first thrust pad and (2) the thrust disc and the second thrust pad, the aerophilic material coating to mitigate movement of the thrust disc along a centerline axis of the rotor shaft.

The example air foil bearing assembly of any preceding clause, wherein the aerophilic material coating conforms to a surface to which the aerophilic material coating is applied, wherein air retained between the aerophilic material coating and the surface is to be released by capillary action when the coating is compressed against the surface.

An example radial air foil bearing comprising a top foil coupled to a rotor shaft, the top foil and rotor shaft to rotate, a bump foil aligned circumferentially around the top foil, the top foil to engage with the bump foil as the top foil rotates, and a micro lattice structure between the top foil and the bump foil, the micro lattice structure to mitigate the top foil engaging with the bump foil.

The example radial air foil bearing of any preceding clause, wherein the micro lattice structure is coupled to the top foil.

The example radial air foil bearing of any preceding clause, wherein the micro lattice structure is coupled to the bump foil.

The example radial air foil bearing of any preceding clause, wherein the micro lattice structure is a first micro lattice structure, and further including a second micro lattice structure, the second micro lattice structure between the top foil and the bump foil.

The example radial air foil bearing of any preceding clause, wherein the micro lattice structure entraps fluid within the micro lattice structure.

The example radial air foil bearing of any preceding clause, wherein the fluid is at least one of air, supercritical carbon dioxide, hydrogen, helium, and nitrogen.

The example radial air foil bearing of any preceding clause, wherein the micro lattice structure comprises at least one of graphite, graphene, nickel, titanium, aluminum, steel, and a composite metal foam.

The example radial air foil bearing of any preceding clause, wherein the micro lattice structure is at least one of electro-deposited, cold sprayed, or three-dimensionally-printed.

The example radial air foil bearing of any preceding clause, further including a perforated plate, the perforated plate to retain a fluid. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An axial air foil bearing comprising:
a thrust disc coupled to a rotor shaft, the thrust disc and the rotor shaft to rotate;
a thrust pad aligned with a first side of the thrust disc, the thrust disc to move towards the thrust pad as the thrust disc rotates; and
a micro lattice structure between the thrust disc and the thrust pad, the micro lattice structure to mitigate the thrust pad engaging with the thrust disc.

2. The axial air foil bearing of claim 1, wherein the micro lattice structure is coupled to the thrust disc.

3. The axial air foil bearing of claim 1, wherein the micro lattice structure is coupled to the thrust pad.

4. The axial air foil bearing of claim 1, wherein the thrust pad is a first thrust pad, and further including:
a second thrust pad, the second thrust pad aligned with a second side of the thrust disc, the first side of the thrust disc opposite the second side of the thrust disc.

5. The axial air foil bearing of claim 4, wherein the micro lattice structure is a first micro lattice structure, and further including:
a second micro lattice structure, the second micro lattice structure between the second thrust pad and the second side of the thrust disc.

6. The axial air foil bearing of claim 1, wherein the micro lattice structure, in a decompressed state, entraps fluid therein.

7. The axial air foil bearing of claim 6, wherein the fluid is at least one of air, supercritical carbon dioxide, hydrogen, helium, and nitrogen.

8. The axial air foil bearing of claim 1, wherein the micro lattice structure comprises at least one of graphite, graphene, nickel, titanium, aluminum, steel, and a composite metal foam.

9. The axial air foil bearing of claim 1, wherein the micro lattice structure is at least one of electro-deposited, cold sprayed, or three-dimensionally-printed.

10. The axial air foil bearing of claim 1, further including a perforated plate between the thrust pad and the thrust disc, the perforated plate to retain a fluid.

11. An air foil bearing assembly including:
a rotor shaft to rotate within a housing;
a thrust disc fixed to the rotor shaft;
a first thrust pad fixed to the housing and aligned with a first side of the thrust disc, the thrust disc to move towards the first thrust pad as the thrust disc rotates;
a second thrust pad fixed to the housing and aligned with a second side of the thrust disc, the thrust disc to move towards the second thrust pad as the thrust disc rotates; and
a micro lattice structure between the thrust disc and at least one of the first thrust pad and the second thrust pad, the micro lattice structure to mitigate movement of the thrust disc along an axis of the rotor shaft.

12. The air foil bearing assembly of claim 11, wherein the micro lattice structure is coupled to the thrust disc.

13. The air foil bearing assembly of claim 11, wherein the micro lattice structure is coupled to the thrust pad.

14. The air foil bearing assembly of claim 11, wherein the micro lattice structure is a first micro lattice structure between the first side of the thrust disc and the first thrust pad, and further including:
a second micro lattice structure, the second micro lattice structure between the second thrust pad and the second side of the thrust disc.

15. The air foil bearing assembly of claim 11, wherein the micro lattice structure, in a decompressed state, entraps fluid therein.

16. The air foil bearing assembly of claim 15, wherein the fluid is at least one of air, supercritical carbon dioxide, hydrogen, helium, and nitrogen.

17. The air foil bearing assembly of claim 11, wherein the micro lattice structure comprises at least one of graphite, graphene, nickel, titanium, aluminum, steel, and a composite metal foam.

18. The air foil bearing assembly of claim 11, wherein the micro lattice structure is at least one of electro-deposited, cold sprayed, or three-dimensionally-printed.

19. The air foil bearing of claim 11, further including a perforated plate between the thrust disc and at least one of the first thrust pad and the second thrust pad, the perforated plate to retain a fluid.

20. An air foil bearing assembly comprising:
a rotor shaft to rotate within a housing;
a thrust disc fixed to the rotor shaft;
a first thrust pad fixed to the housing and aligned with a first side of the thrust disc, the thrust disc to move towards the first thrust pad as the thrust disc rotates;
a second thrust pad fixed to the housing and aligned with a second side of the thrust disc, the thrust disc to move towards the second thrust pad as the thrust disc rotates; and
an aerophilic material coating between at least one of (1) the thrust disc and the first thrust pad and (2) the thrust disc and the second thrust pad, the aerophilic material coating to mitigate movement of the thrust disc along a centerline axis of the rotor shaft.
